(19) United States
(12) Patent Application Publication
(10) Pub. No.: US 2014/0254838 A1
(43) Pub. Date: Sep. 11, 2014

(54) METHOD AND APPARATUS FOR CONTROLLING AUDIO OUTPUT OF COMMUNICATION TERMINAL

(71) Applicant: Samsung Electronics Co., Ltd., Gyeonggi-do (KR)

(72) Inventor: Jong-Hyun LEE, Gyeonggi-do (KR)

(73) Assignee: Samsung Electronics Co., Ltd., Gyeonggi-do (KR)

(21) Appl. No.: 14/196,113

(22) Filed: Mar. 4, 2014

(30) Foreign Application Priority Data
Mar. 5, 2013 (KR) 10-2013-0023400

(51) Int. Cl. H04R 3/00

(52) U.S. Cl. CPC H04R 3/00
USPC 381/123

(57) ABSTRACT

An apparatus for controlling an audio output in a terminal includes: a speaker; an audio processor which demodulates an audio signal via a first path and a second path having different impedances from each other, the audio processor selectively transmits the demodulated audio signal to the speaker via one of the first path and the second path; and a controller which determines an audio output mode and controls a path selection of the audio processor according to the determined audio output mode.

### CROSS REFERENCE TO RELATED APPLICATION

This application claims the priority under 35 U.S.C. §119(a) to Korean Application Serial No. 10-2013-0023400, which was filed in the Korean Intellectual Property Office on Mar. 5, 2013, the entire content of which is hereby incorporated by reference.

### BACKGROUND

1. Technical Field

The present disclosure relates to a method and apparatus for controlling an audio output of a communication terminal

2. Description of the Related Art

Referring to FIG. 1A, a conventional communication terminal includes a single receiver 13 for outputting a voice sound and a single speaker 14 for outputting a bell sound.

Referring to FIG. 1B, the communication terminal also provides a multimedia function for listening to music and watching videos, or the like. To this end, the communication terminal includes at least two speakers 14 for outputting a stereo sound effect.

Referring to FIG. 1C, the communication terminals as described above determine an output level of an audio signal and then selectively output an audio signal having a determined output level to a speaker or a receiver. To achieve this, the communication terminal includes a controller 11, a codec 12, a speaker 14, and a receiver 13.

In operation, the controller 11 transmits an input audio signal to the codec 12 and then determines an output level of a corresponding audio signal. Further, the controller 11 controls the codec 12 to cause a demodulated audio signal to have a determined output level at the time of demodulation of the audio signal. In addition, the controller 11 controls the codec 12 to output the demodulated audio signal to one of the speaker 14 or the receiver 13.

The codec 12 demodulates an audio signal input from the controller 11 and then outputs the demodulated audio signal to one of the speaker 14 or the receiver 13 under a control of the controller 11.

The speaker 14 and the receiver 13 output the demodulated audio signal received from the codec. Herein, the speaker 14 is designed so as to have an impedance lower than that of the receiver 13. Accordingly, an audio signal output to the speaker 14 has an output level higher than an audio signal output to the receiver 13.

In the construction as described above, a timing control error may occur in the controller 11 or an output level may be suddenly changed because of a communication error environment. Here, when an audio output level is output to the receiver 13 with a high output level without being controlled in optimum levels, an acoustic shock may occur to affect user's hearing.

Moreover, mounting both the speaker 14 and the receiver 13 as described above works against a current trend of miniaturization and slimming the device, and further increases the manufacturing costs.

### SUMMARY

Accordingly, an aspect of the present invention is to provide a scheme for supporting a voice telecommunication and a multimedia function by using a speaker.

According to another aspect of the invention, an apparatus for controlling an audio output in a terminal includes: a speaker; an audio processor which demodulates an audio signal via a first path and a second path having different impedances from each other, the audio processor selectively transmits the demodulated audio signal to the speaker via one of the first path and the second path; and a controller which determines an audio output mode and controls a path selection of the audio processor according to the determined audio output mode.

According to another aspect of the invention, a method for controlling an audio output in a terminal includes: demodulating an audio signal; determining an audio output mode; selectively selecting one of a first path and a second path having different impedances from each other according to the determined audio output mode; and outputting the demodulated audio signal to a speaker through the selected path.

According to the present invention, there is an advantage in which manufacturing costs can be reduced by causing a speaker to also perform a receiver function. Further, according to the present invention, there is an advantage in which an acoustic shock caused by a program error or a communication environment error is prevented by controlling an output level of an audio signal through an impedance.

### BRIEF DESCRIPTION OF THE DRAWINGS

The above and other aspects, features, and advantages of the present invention will be more apparent from the following detailed description taken in conjunction with the accompanying drawings, in which:

FIG. 1A, FIG. 1B, and FIG. 1C are diagrams illustrating a construction of a conventional terminal;

FIG. 2A and FIG. 2B are conceptual diagrams illustrating a terminal to which embodiments of the present invention are applied;

FIG. 3 is a block diagram illustrating a construction of a terminal to which embodiments of the present invention are applied;

FIG. 4 is a flowchart illustrating an example of a process of determining an audio output mode when call establishment or call origination is requested according to an embodiment of the present invention;

FIG. 5 is a flowchart illustrating an example of a process of determining an audio output mode based on sensing information relating to a terminal operation state according to an embodiment of the present invention;

FIG. 6 is a block diagram illustrating an example of a construction of an audio processor according to an embodiment of the present invention; and

FIG. 7 is a block diagram illustrating an example of a construction of an audio processor according to another embodiment of the present invention.

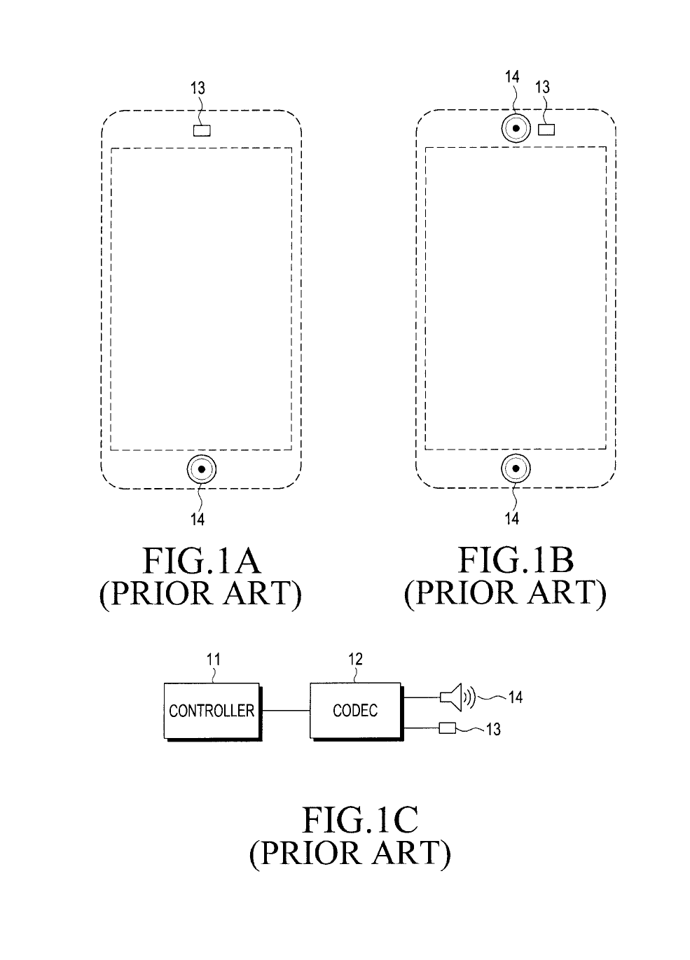

### DETAILED DESCRIPTION

Hereinafter, various embodiments of the present invention will be described with reference to the accompanying drawings. For the purposes of clarity and simplicity, a detailed description of known functions and configurations incorporated herein will be omitted as it may make the subject matter of the present invention unclear.

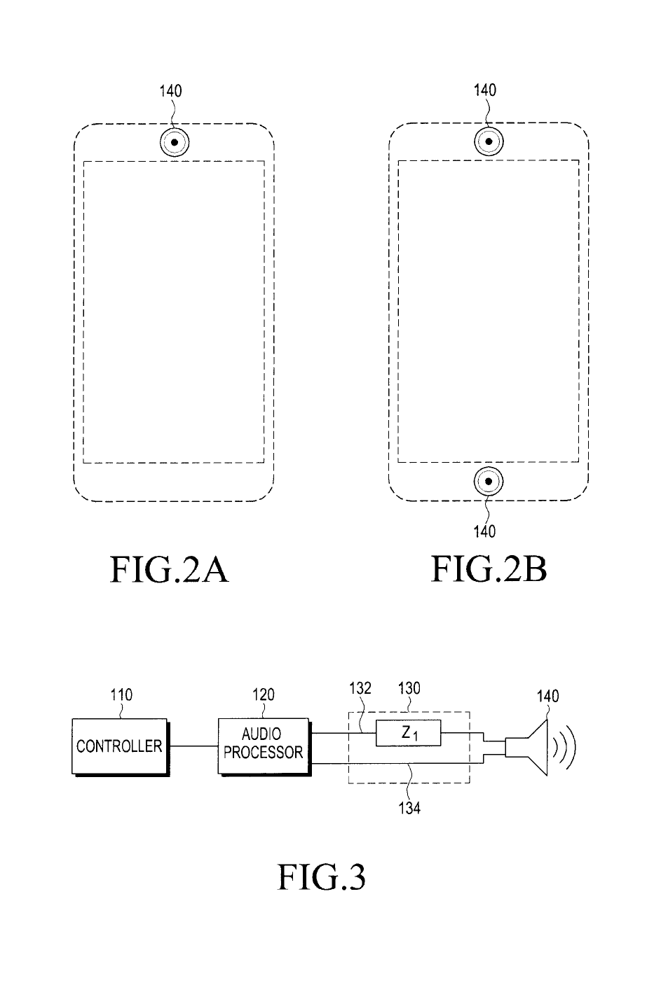

FIGS. 2A and 2B are conceptual diagrams illustrating a terminal to which embodiments of the present invention are applied. In embodiments of the present invention, a terminal may include a speaker 140 as shown in FIG. 2A or include two speakers 140 as shown in FIG. 2B. According to the embodiment, the terminal may include three or more speakers.

In embodiments of the present invention, the terminal may operate as one mode among a speaker mode and a receiver mode. In embodiments of the present invention, the terminal outputs an audio signal having an output level higher than that of the receiver mode during the speaker mode and outputs an audio signal having an output level lower than that of the speaker mode during the receiver mode.

In embodiments of the present invention, the receiver mode refers to a mode for causing a highest value (e.g., 0.5 W) of output level of the speaker to be lower than or equal to a predetermined value. For example, the receiver mode may be a mode necessary for a user to perform a voice telecommunication in a state in which the user places the terminal close to the ear.

Meanwhile, in embodiments of the present invention, the speaker mode refers to a mode in which a highest value of output level is higher than that of the receiver mode. For example, the speaker mode may include a speaker phone telecommunication mode in which a user performs a voice telecommunication in a state in which the user does not place the terminal close to the ear, and a multimedia mode for listening to music, watching videos, or the like.

According to the embodiment of the present invention, there is an advantage in that both a receiver function and a speaker function can be implemented by just the speaker without using the receiver.

Meanwhile, as shown in FIG. 2B, when the terminal includes a plurality of speakers 140, the terminal may enable an audio signal to be output with only a single speaker during the receiver mode.

Hereinafter, a construction of the terminal according to embodiments of the present invention will be described in more detail with reference to the relating drawings.

FIG. 3 is a block diagram illustrating a construction of a terminal to which embodiments of the present invention are applied.

Referring to FIG. 3, a terminal to which the embodiments of the present invention are applied may include a controller 110, an audio processor 120, a path unit 130, and a speaker 140.

The terminal according to the embodiment may include an electronic device or any duplex system, such as portable electronic device, hand-held portable terminal, mobile station, Personal Digital Assistant (PDA), laptop computer, smart phone, netbook, television, Mobile Internet Device (MID), Ultra Mobile Personal Computer (UMPC), tablet PC, desktop computer, smart TV, digital camera, wrist watch, navigation system, and MP3 player. The electronic device may be a wireless electronic device combining two or more functions of those devices. When an audio output is requested, the controller 110 transmits an input audio signal to the audio processor 120. A case in which the audio output is requested represents a scenario in which a menu for performing a multimedia, for example, music, videos, or the like, is selected, or a case in which a menu for call establishment or call origination is selected.

When the menu for performing the multimedia function has been selected, the controller 110 obtains a corresponding multimedia source from a memory (not shown) and then transmits the corresponding multimedia source to the audio processor 120. Accordingly, the controller 110 may cause the corresponding multimedia source to be directly transmitted from the memory to the audio processor 120 by controlling the memory.

Meanwhile, when in response to a call termination request from a counterpart, a menu for call establishment has been selected or a menu for call origination has been selected, the controller 110 transmits an audio signal transmitted from the communication unit (not shown) to the audio processor 120. To this end, the communication unit may transmit and receive a voice signal required for a telecommunication and data required for a data communication under a control of the controller 110.

Further, the controller 110 determines an audio output mode. That is, the controller 110 determines one of the receiver mode and the speaker mode as the audio output mode and controls the audio processor 120 to output an audio signal according to the determined audio output mode.

The audio processor 120 demodulates an audio signal received from the controller 110 and then outputs the demodulated audio signal to the speaker 140 through the path unit 130. Here, under the control of the controller 110, the audio processor 120 determines one path, through which the demodulated audio signal is to be transmitted, among a first path 132 and a second path 134 of the path unit 130, and then transmits the demodulated audio signal through the determined path.

The path unit 130 includes the first path 132 and the second path 134. The first path 132 and the second path 134 have different impedances from each other. In an embodiment, an impedance of the first path 132 is higher than an impedance of the second path 134 and the impedance of the second path 134 may be 0 or a value lower than the impedance Z₁ of the first path 132.

The speaker 140 has a predetermined impedance and outputs an audio signal received through the path unit 130.

In a terminal having a construction as shown in FIG. 3, the controller 110 determines the audio output mode and then controls the audio processor 120 according to the determination outcome.

When the receiver mode has been determined as a current audio output mode, the controller 110 may control the audio processor 120 to transmit the audio signal to the speaker 140 through the first path 132.

As described above, the first path 132 includes an impedance Z₁ having a predetermined value. Accordingly, in the receiver mode, an audio signal via the first path 132 has an output level lower and an audio signal output to the speaker 140 thus has an output level lower than or equal to a predetermined level according to an impedance Z₁ value.

For example, when it has been determined that the user is performing a voice telecommunication in a state in which the user places the terminal close to the ear, the controller 110 determines the receiver mode as the audio output mode and then lower the audio output level below the predetermined output level, so as to prevent the occurrence of an acoustic shock.

Meanwhile, when the speaker mode has been determined as the current audio output mode, the controller 110 may control the audio processor 120 to transmit the audio signal to the speaker 140 through the second path 134.

As illustrated above, the second path 134 does not have an impedance so that an audio signal having an output level higher than that of the audio signal via the first path 132 can be output.

For example, when it has been determined that a user does not hold a mobile terminal even though a voice telecommunication is performed, the controller 110 may determine the audio output mode as the speaker mode. For example, this case may be a case in which a user performs a voice telecommunication by using a speaker function in a state of putting the terminal on a table or a case in which a user performs a video telecommunication without placing the terminal close to the ear. In addition, when multimedia such as music, videos, or the like is being played, the controller 110 may determine the audio output mode as the speaker mode.

In an alternate embodiment, an impedance may be added to the second path 134. In this event, the impedance value added to the second path may be set to a value lower than an impedance value of the first path.

According to the embodiment as described above, there is an advantage that the present invention can use both the receiver function and the speaker function with only one speaker without using a receiver.

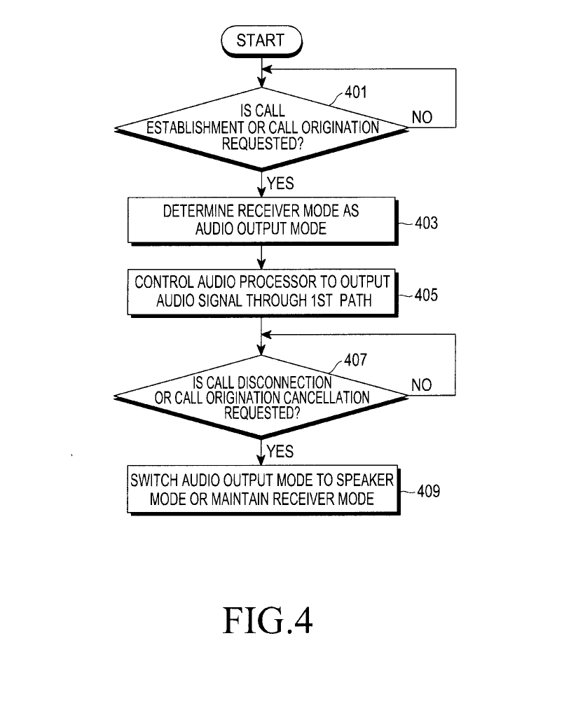

FIG. 4 is a flowchart illustrating an example of a process of determining an audio output mode when a call establishment or a call origination is requested according to an embodiment of the present invention.

In step 401, a controller 110 determines whether a call establishment or a call origination is requested. When the call establishment or the call origination has been requested, the controller 110 performs in step 403. For example, a case in which the call establishment is requested is when a user selects a button or a menu for establishing a connection in response to a call requested from a counterpart. Also, for example, a case in which call origination is requested is when a user selects a button or a menu for initiating the call origination after inputting a phone number.

After determining that the call establishment or call origination has been requested, the controller 110 determines the receiver mode as the audio output mode and then performs step 405.

In step 405, the controller 110 controls an audio processor to output the audio signal through a path corresponding to the receiver mode, and then performs in step 407. To this end, the controller 110 controls the audio processor 120 to output the audio signal through the first path 132. Therefore, the audio processor 120 transmits an audio signal input from the controller 110, a memory (not shown), or the like to the speaker 140 through the first path 132.

In step 407, the controller 110 determines whether the call disconnection or call origination cancellation is requested. If so, the controller 110 performs in step 409.

Thereafter, in step 409, the controller 110 switches the audio output mode to the speaker mode or maintains the receiver mode.

According to the embodiment as described above, when the call establishment or call origination has been requested, the audio signal is output through a path having a predetermined impedance so that the audio signal having a low output level can be output. That is, while the user performs a voice communication, the controller 110 may lower the audio output level, so as to prevent the occurrence of an acoustic shock.

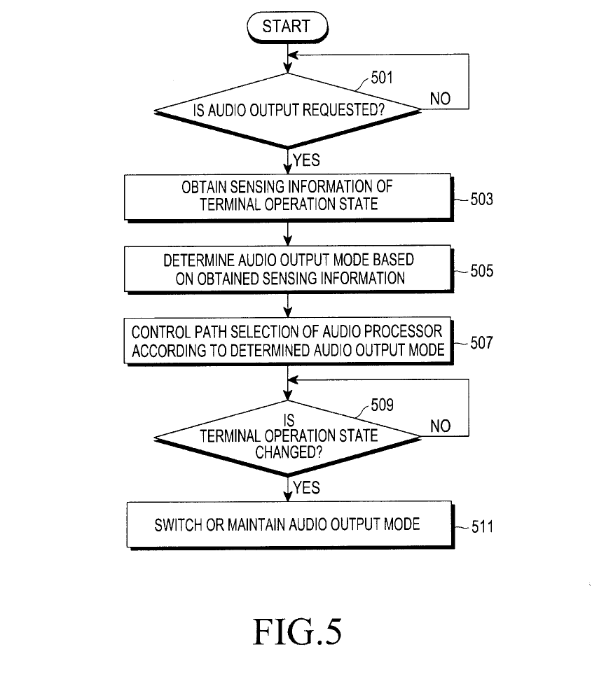

FIG. 5 is a flowchart illustrating an example of a process of determining an audio output mode based on sensing information relating to a terminal operation state according to an embodiment of the present invention.

In step 501, a controller 110 determines whether the audio output is requested. When the audio output has been requested, the controller 110 performs in step 503. For example, a case in which the audio output is requested is when a menu for performing a function of a multimedia such as music, videos, or the like is selected, or when a menu for call termination or call origination is selected.

In step 503, the controller 110 obtains sensing information relating to a terminal operation state using a proximity sensor (not shown) installed in the terminal, and then performs in step 505. For example, the sensing information relating to the terminal operation state includes one or more combinations of holding information representing whether the user holds the terminal and proximity information representing whether the user places the terminal close to the ear.

In step 505, the controller 110 determines the audio output mode based on the obtained sensing information. For example, the controller 110 analyzes the proximity information received from a proximity sensor (not shown). In one embodiment, the proximity sensor may be provided at a front part of the terminal, i.e., on a surface at which a speaker is located. When it has been determined that the user is using the terminal in a state in which the user is close to the terminal within a preset distance, the controller 110 may determine the receiver mode as the audio output mode. For example, this may be a case in which the user places the terminal close to his or her ear for a voice communication, or the like. On the other hand, when it has been determined that a user is spaced a preset distance from the terminal, based on an analysis of the proximity information received from the proximity sensor, the controller 110 may determine the speaker mode as the audio output mode.

Further, for example, when it has been determined that the user holds the terminal, based on an analysis of holding information received from a grip sensor (not shown), the controller 110 may determine the receiver mode as the audio output mode. To this end, the terminal according to an embodiment of the present invention may include a grip sensor. In one embodiment, the grip sensor may be provide on at least one surface among a front surface, a rear surface, and a lateral surface of the terminal. On the other hand, when it has been determined that the user does not hold the terminal, based on an analysis of the holding information received from the grip sensor (not shown), the controller 110 may determine the speaker mode as the audio output mode.

According to the embodiment, the controller 110 may determine the audio output mode based on both the proximity information and the holding information. For example, when it has been determined that the user holds the terminal in a state in which the user is close to the terminal within a preset distance, the controller 110 may determine the receiver mode as the audio output mode. Further, for example, even though it has been determined that the user holds the terminal, based on an analysis of the holding information, the controller 110 may determine the speaker mode as the audio output mode when it has been determined that the user does not place the terminal close to the ear. According to the embodiment, the controller 110 may determine the audio output mode based on only one information of the proximity information and the holding information.

In step 507, the controller 110 controls a path selection of the audio processor 120 to output the audio signal according to the determined audio output mode, and then performs in step 509. For example, in the construction as illustrated in FIG. 3, when the receiver mode has been determined as the audio output mode, the controller 110 controls the audio processor 120 to output the audio signal through the first path 132. Meanwhile, when the speaker mode has been determined as the audio output mode, the controller 110 controls the audio processor 120 to output the audio signal through the second path 134.

In step 509, the controller 110 determines whether a terminal operation state is changed. When the terminal operation state has been changed, the controller 110 performs in step 511. To this end, the controller 110 continuously obtains the sensing information from at least one sensor of the proximity sensor and the grip sensor.

In step 511, the controller 110 switches or maintains the audio output mode.

According to the embodiment described above with reference to FIG. 5, there is an advantage in which the audio signal having an output level appropriate to the terminal operation state can be output.

Hereinafter a construction of the audio processor 120 according to embodiments of the present invention will be described.

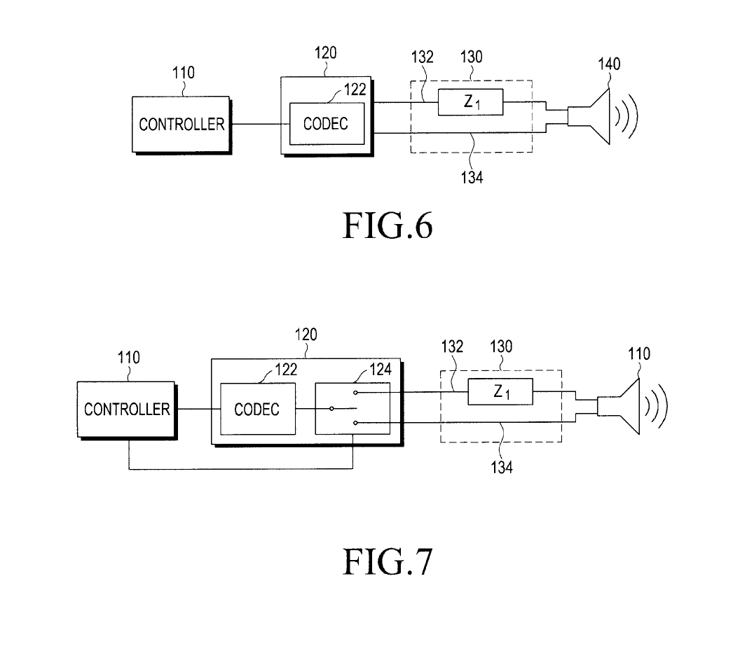

FIG. 6 is a block diagram illustrating an example of a construction of an audio processor according to an embodiment of the present invention.

Referring to FIG. 6, an audio processor 120 according to an embodiment of the present invention includes a codec 122.

A controller 110 controls a path selection of the codec. That is, the controller 110 controls the codec 122 to output a demodulated audio signal through one path of a first path 132 and a second path 134 included in a path unit 130. Further, the controller 110 may control the codec 122 to demodulate an audio signal having a predetermined output level.

The codec 122 demodulates an input audio signal under a control of the controller 110 and then selects an output path of the demodulated audio signal. In addition, the codec 122 outputs the demodulated audio signal to a speaker 140 through the selected path.

FIG. 7 is a block diagram illustrating an example of a construction of an audio processor according to another embodiment of the present invention.

Referring to FIG. 7, an audio processor 120 according to another embodiment of the present invention includes a codec 122 and a switch 124.

A controller 110 controls the codec 122 to demodulate an audio signal having a predetermined output level. Further, the controller 110 controls the switch 124 to output the audio signal demodulated by the codec 122 through one path of a first path 132 and a second path 134 included in a path unit 130.

The codec 122 demodulates the input audio signal under the control of the controller 110 and then outputs the demodulated audio signal to a speaker 140 through a path connected by the switch 124.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Furthermore, there may be various embodiments and modified embodiments of the present invention. Therefore, the scope of the present invention may not be defined by the described embodiments but shall be defined by the spirit and scope of the appended claims

What is claimed is:

1. An apparatus for controlling an audio output in a terminal, comprising:
a speaker;
an audio processor which demodulates an audio signal via a first path and a second path having different impedances from each other, the audio processor selectively transmits the demodulated audio signal to the speaker via one of the first path and the second path; and
a controller which determines an audio output mode and controls a path selection of the audio processor according to the determined audio output mode.

2. The apparatus of claim 1, wherein, when the determined audio output mode is a second output mode which requires an output level lower than that of a first output mode, the controller controls the audio processor to select the second path having an impedance higher than that of the first path.

3. The apparatus of claim 2, wherein the first output mode is a speaker mode and the second output mode is a receiver mode.

4. The apparatus of claim 3, wherein, when a call establishment or a call origination has been requested, the controller determines the audio output mode as the receiver mode.

5. The apparatus of claim 1, wherein the audio processor comprises:
a codec which demodulates the audio signal; and
a switch which selects an output path of the demodulated audio signal under a control of the controller.

6. The apparatus of claim 1, further comprising a sensor unit which obtains sensing information relating to a terminal operation state,
wherein the controller determines the audio output mode based on the sensing information relating to the terminal operation state received from the sensor unit.

7. The apparatus of claim 6, wherein, when it is determined that the terminal is being held, as a result of analyzing the sensing information of the terminal operation state, the controller determines a receiver mode as the audio output mode.

8. The apparatus of claim 6, wherein, when it is determined that a user is close to the terminal within a preset distance, as a result of analyzing the sensing information of the terminal operation state, the controller determines a receiver mode as the audio output mode.

9. The apparatus of claim 6, wherein the controller continuously receives the sensing information relating to the terminal operation state from the sensor unit and analyzes the sensing information, and switches the audio output mode when it is determined that the terminal operation state has been changed.

10. The apparatus of claim 6, wherein the sensor unit comprises one or more combinations of a grip sensor and a proximity sensor.

11. A method for controlling an audio output in a terminal, comprising:
demodulating an audio signal;
determining an audio output mode;
selectively selecting one of a first path and a second path having different impedances from each other according to the determined audio output mode; and
outputting the demodulated audio signal to a speaker through the selected path.

12. The method of claim 11, wherein, when the determined audio output mode is a second output mode which requires an output level lower than a that of first output mode, selecting the second path having an impedance higher that of the first path.

13. The method of claim 12, wherein the first output mode is a speaker mode and the second output mode is a receiver mode.

14. The method of claim 13, wherein, when a call establishment or a call origination is requested, determining the receiver mode as the audio output mode.

15. The method of claim 11, wherein determining the audio output mode comprises determining the audio output mode based on sensing information relating to a terminal operation state.

16. The method of claim 15, wherein, when it is determined that the terminal is being held as a result of analyzing the sensing information of the terminal operation state, determining a receiver mode as the audio output mode.

17. The method of claim 15, wherein, when a user is close to the terminal within a preset distance as a result of analyzing the sensing information of the terminal operation state, determining a receiver mode as the audio output mode.

18. The method of claim 15, wherein determining the audio output mode comprises: continuously receiving the sensing information relating to the terminal operation state, analyzing the sensing information, and switching the audio output mode when it is determined that the terminal operation state has been changed.

19. The method of claim 16, wherein the sensing information relating to the terminal operation state comprises at least one of grip information and proximity information.
